(19) United States
(12) Patent Application Publication
(10) Pub. No.: US 2010/0202843 A1
(43) Pub. Date: Aug. 12, 2010

(54) REAMER

(75) Inventor: Dieter Kress, Aalen (DE)

Correspondence Address: HARNESS, DICKEY & PIERCE, P.L.C., P.O. BOX 828, BLOOMFIELD HILLS, MI, 48303, US

(73) Assignee: Mapal Fabrik Fur Prazisionswerkzeuge Dr. Kress KG, Aalen (DE)

(21) Appl. No.: 12/676,119

(22) PCT Filed: Sep. 2, 2008
(86) PCT No.: PCT/EP08/07144

§ 371 Date: Mar. 2, 2010

(30) Foreign Application Priority Data
Sep. 4, 2007 (DE) 10 2007 041 935.1
Oct. 2, 2007 (DE) 10 2007 048 634.2

(51) Int. Cl. B23D 77/04

(52) U.S. Cl. 408/153; 408/147

(57) ABSTRACT

The invention proposes a reamer having
a base (3),
at least one cutting tip (13) disposed essentially parallel to a face (11) of the reamer (1) that comprises
a geometrically defined major cutting edge (27) and a geometrically defined minor cutting edge (29) and
is held on a contact surface (19) of the base (3) of the reamer (1) by a tightening screw (39) penetrating the cutting tip (13), with a back (17) of the cutting tip (13) resting on the contact surface (19),
having an adjustment unit having
an adjustment screw acting on the cutting tip (13) that introduces adjustment forces into a lateral surface of the cutting tip (13).

The reamer is characterized in that
the recess (35) accommodating the tightening screw (39) penetrating the cutting tip (13) comprises a clamping region (57) and in that
the distance from the clamping region (57) to the rear (17) of the cutting tip (13) measured perpendicular to the rear (17) is equal to the distance from the engagement region of the adjustment forces to the rear (17) of the cutting tip (13) measured perpendicular to the rear (17) of the cutting tip (13).

The invention relates to a reamer according to the pre-characterizing portion of claim 1.

Reamers of the type discussed here are known. They comprise a base, at least one cutting tip disposed essentially parallel to a face of the reamer as well as an adjustment unit. The at least one cutting tip comprises one major cutting edge and one minor cutting edge adjacent thereto. As a rule, the major cutting edge is inclined in the feed direction of the tool and the minor cutting edge is inclined in the opposite direction. For good surface qualities of the machined bore, it is crucial that a decline, described as a tapering, of 1μ to 3μ, preferably of 1μ to 1 mm, results in the region of the minor cutting edge and that said decline be maintained even when the diameter of the reamer is adjusted. It has been shown that the tapering of the minor blade often changes and must be reset when the diameter of the reamer is adjusted because otherwise high surface qualities of the machined bore cannot be guaranteed.

The object of the invention is therefore to create a reamer that prevents the disadvantages mentioned above.

In order to attain this object, the invention proposes a reamer of the type mentioned at the outset that has the features listed in claim 1. Therefore, it comprises a base, at least one cutting edge, and an adjustment unit. The cutting edge comprises at least one geometrically defined major cutting edge and minor cutting edge. It is fixed on a contact surface of the base by a tightening screw, with the back of the cutting tip resting against this contact surface. The adjustment unit serves to adjust the major cutting edge and minor cutting edge in such a way that they protrude somewhat past the circumferential surface of the reamer and engage with the wall of the bore upon insertion of the tool into a bore to be machined. To this end, the adjustment unit comprises an adjustment screw that introduces adjustment forces in an engagement area onto a lateral surface of the cutting tip in such a way that the protrusion may be adjusted. The reamer is characterized in that the recess provided in the cutting tip and serving to accommodate the tightening screw comprises a clamping area. This clamping area is disposed at a certain distance from the back of the cutting tip. The engagement area of the adjustment screw on the lateral surface of the cutting tip is also located at a distance from the back of said cutting tip. The distinctive feature of the reamer is that the distance from the clamping area to the back of the cutting tip and the distance from the engagement area to the back of the cutting tip are equal. The forces exerted by the clamping area of the tightening screw on the cutting tip and onto the lateral wall of the cutting tip via the adjustment screw lie in a plane that is preferably disposed parallel to the back of the cutting tip. It appears that, in such a design of the reamer, no tilting moment acts on the reamer when the cutting tip is adjusted and an optimal contact on the contact surface is guaranteed. The cutting tip pressed against the contact surface by the tightening screw therefore slides along this contact surface with its back without tilting. The contact surface lies essentially parallel to the face of the reamer; however, viewed from the central axis of the reamer in the direction of its circumferential surface, it is inclined in such a way that it declines by 1μ per 1 mm. Because the cutting region of the cutting tip is disposed perpendicular to its back, the minor cutting edge also declines by 1μ per 1 mm in such an arrangement. If the cutting tip is displaced in a parallel fashion relative to the contact surface, the tapering in the region of the minor cutting edge is precisely maintained, even when the reamer is adjusted. This is in particular due to the fact that the adjustment forces do not cause any tilting moment, such that the back of the cutting tip is always securely resting on the contact surface. Preferably, provision is also made for the adjustment screw to form an angle, preferably an acute angle, with the face of the reamer.

A particularly preferred exemplary embodiment of the reamer is characterized in that the clamping region in the recess placed in the cutting tip that serves to accommodate the tightening screw is embodied as an arced surface or as an inner cone. Correspondingly, an outer cone is provided on the tightening screw, such that it centers the cutting tip around the central axis of the tightening screw. This results in a more secure hold on the contact surface in the base of the reamer. Moreover, the clamping forces may be transferred to the cutting tip in a defined region of the recess. This makes it easier to align the introduction of the adjustment forces into a lateral surface of the cutting tip precisely onto this clamping region in such a way that, when the cutting tip is adjusted, no tilting moment is introduced into the cutting tip.

Other refinements of the invention may be found in the subordinate claims.

The invention shall be described in greater detail in the following with reference to the drawings, which show:

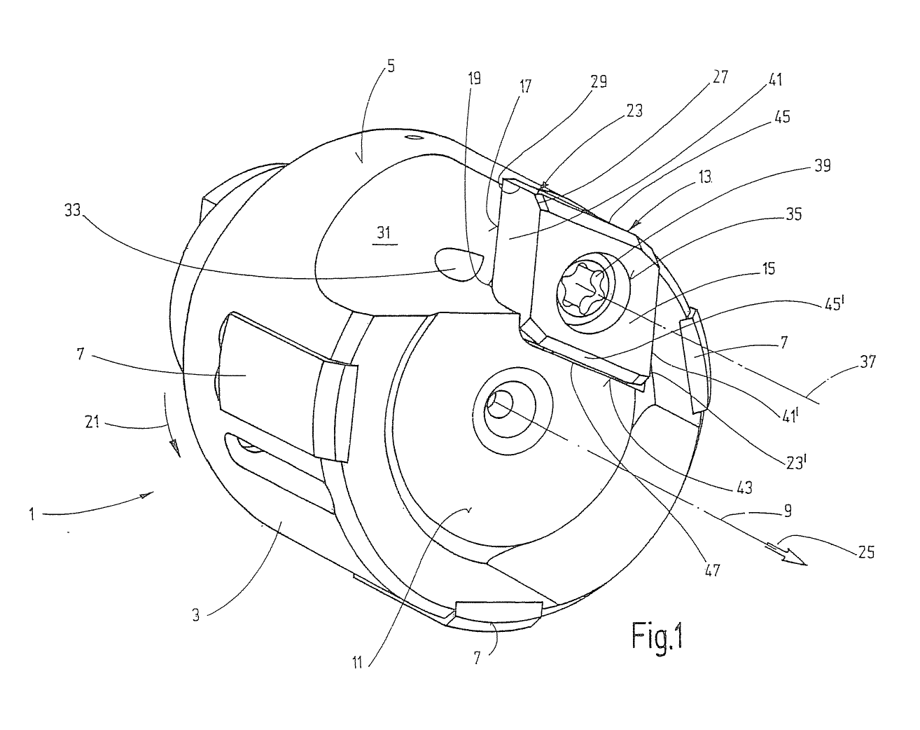

FIG. 1 a perspective front view of an exemplary embodiment of the reamer with a cutting tip and three guide strips;

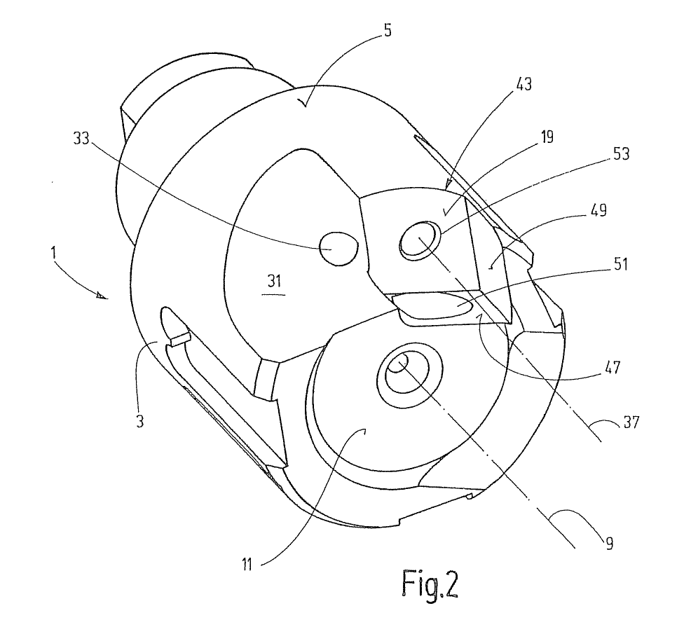

FIG. 2 a perspective view of the base of the reamer according to FIG. 1 without the cutting tip and without the guide strips; and

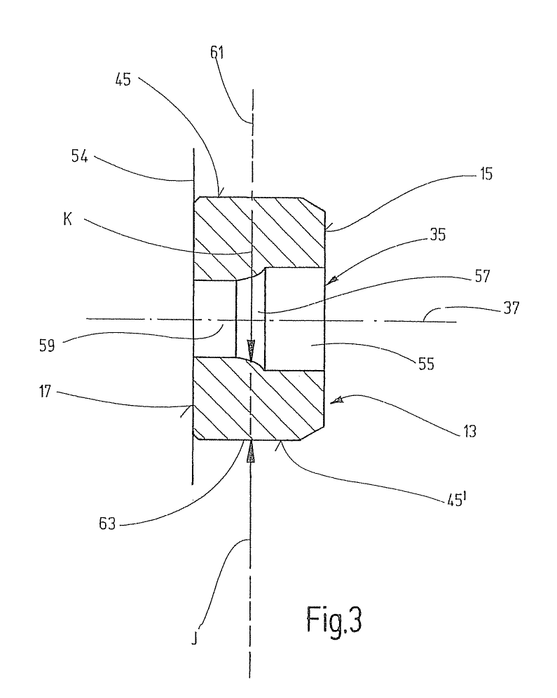

FIG. 3 a schematic section through a cutting tip resting on a contact surface.

The tool shown in FIG. 1 for machining work pieces is a reamer 1 having a base 3, in the circumferential surface 5 of which at least one, in this case three, guide strips 7 have been placed that run essentially parallel to the rotational or central axis 9 of the reamer 1. At least one cutting tip is inserted into the face 11 of the reamer 1 in an essentially tangential fashion. In the exemplary embodiment of the reamer 1 shown here, one single cutting tip 13 has been provided, whose front 15 is facing the observer and whose back 17 is resting on a contact surface 19 on the base 3 of the reamer 1 that is virtually completely covered. The reamer 1 serves to remove chips from a bore. To this end, the tool is usually caused to rotate and inserted into a bore of a stationary work piece. It is fundamentally conceivable for the reamer 1 to be held stationary and for the work piece to be rotated. If, as is common, the reamer 1 is caused to rotate in the direction of the arrow 21, then chips are removed from the surface of a bore by a cutting region 23 of the cutting tip 9 that protrudes past the circumferential surface 5 in the radial direction, i.e., perpendicular to the central axis 9. When machining the work piece, the reamer 1 is fed forward in the direction of the double arrow 25, i.e., in the direction of its central axis 9.

From FIG. 1, it can be seen that a section of the cutting region 23 is inclined in the feed direction. This is the major cutting edge 27 of the cutting tip 13. A section is shown here by way of example that includes only a region that is inclined in the feed direction. However, it is also conceivable for a first region of the major cutting edge to be provided here that is adjacent to the face 11 and that declines by 45°, for example, in the feed direction, and for another region to be provided located behind the first region in the feed direction that is inclined in the feed direction by less than 3° to 5°. Such a design is also referred to as a double gating.

Another section of the cutting region 23, namely the minor cutting edge 29, is adjacent to the major cutting edge 27, optionally adjacent to the less inclined region of the major cutting edge. This minor cutting edge is inclined opposite the feed direction implied by the double arrow 25 and, viewed from the major cutting edge 27, declines by 1μ/mm to 3μ/mm, preferably by 1μ/mm, in the direction of the central axis 9. Such a design of a minor cutting edge is known. It is also referred to as tapering.

In machining a work piece, therefore, chips are first removed from the wall of a bore to be machined by the major cutting edge 27. The region thus machined is subsequently machined by the minor cutting edge 29. The tapering serves to prevent the reamer from jamming in the bore to be machined and to guarantee an optimal surface quality. The minor cutting edge 29, which is inclined relative to the central axis 9, is not necessarily engaged with the surface of the bore over its entire length, which is measured from the major cutting edge 27 to the back 17 of the cutting tip 13. Preferably, provision is made for a region of 3 mm of the minor cutting edge 29 to be active, i.e., engaged with the bore wall of a work piece, said region originating from the inflection point between the major and minor cutting edges.

The chips removed by the cutting region 23 arrive in a recess in the base 3 of the reamer 1 designated as the chip space 31 and may be removed so that the bore surface to be machined is not damaged by chips. A coolant/lubricant may be provided via a channel 33 emptying into the chip space for cooling and for removing the chips, as well as for lubricating the cutting region 23.

A recess 35 is placed in the cutting tip 13 whose longitudinal axis is perpendicular on the front 15 and on the back 17 and on the contact surface 19. A tightening screw 39 by means of which the cutting tip 13 is fastened to the base 3 of the reamer 1 and is pressed with its back 17 against the contact surface 19 extends through the recess 35. The head of the tightening screw 39 is sunk into the recess 35 in the cutting tip 13.

Provision is made for the contact surface 19 to decline in the radial direction, i.e., viewed from the central axis 9 out, in the direction of the circumferential surface 5 of the reamer 1, preferably by 1μ/mm. Because the minor cutting edge 29 runs perpendicular relative to the back 17 of the cutting tip 13, this decline of the contact surface 19 serves to adjust the tapering of the minor cutting edge 29, i.e., its incline relative to the central axis 9. Here, the longitudinal axis 27 of the tightening screw 39 is preferably inclined relative to the central axis in such a way that, as stated above, it stands perpendicular on the contact surface 19.

From the depiction according to FIG. 1, it can be seen that the cutting tip 13—shown in a top view—is designed as a parallelogram. A first lateral surface 41 points in the rotational direction implied by the arrow 21. The opposing side 41′ is adjacent to a limiting wall of a recess 43 placed in the base 3 of the reamer 1, said recess accommodating the cutting tip 13. An exterior longitudinal side 45 of the reamer points outward. An opposing interior longitudinal side 45′ lies against an interior wall 47 of the recess 43. This interior longitudinal side 45′ is being acted upon by an adjustment unit, which is not shown here and which serves to adjust the protrusion of the cutting region 23 past the circumferential surface 5 of the reamer 1, thus adjusting the diameter of the tool.

The cutting tip 23 preferably comprises two cutting regions. A cutting region 23′ is provided diametrically opposite the cutting region 23. In the case of wear on the cutting region 23, the tightening screw 39 may be loosened. The cutting tip 13 is then rotated 180° around the longitudinal axis 37 and placed again in the recess 43 and then fixed in place by means of the tightening screw 39.

FIG. 2 again shows the reamer 1 in a perspective view, albeit rather more from the top than is the case in FIG. 1. In the depiction according to FIG. 2, all of the parts mounted on the base 3 of the reamer 1 have been omitted, i.e., the at least one cutting tip and the at least one guide strip. The same parts have been given the same reference characters; in this regard, reference is made to the description of FIG. 1.

The recess 43 for accommodating the cutting tip 13, which is not shown here, has been placed in the base 3 of the reamer 1. The interior wall 47, a limiting wall 49 opposite the chip space 31, and the support surface 19 of this recess 43 are clearly discernible. An opening 51 may be seen in the region of the interior wall 47, through which an adjustment unit is able to act on the cutting tip 13 so as to be able to adjust the diameter of the reamer 1. The adjustment unit comprises an adjustment screw, which is not shown here, passing through the opening 51 that acts on the interior longitudinal side 45′ of the cutting tip 13. The adjustment screw is preferably disposed in such a way that it and/or its central axis forms a preferably acute angle with the face 11 of the reamer 1.

A bore 53 may be seen in the contact surface 19, whose central axis coincides with the central axis 37 of the tightening screw, which is not shown here. Said bore is located perpendicular to the contact surface 19.

FIG. 3 shows the cutting tip 13 in a sectional view without the reamer. However, a plane 54 is implied here in which the contact surface 19 of the recess 43 lies.

In the sectional view, the recess 35 may be seen in the cutting tip 13. Said recess comprises a first region 55 whose interior diameter is selected such that it is able to accommodate the head of a tightening screw 39. The first region 55 originates from the front 15 of the cutting tip 13. A clamping region 57 is adjacent to the first region, said clamping region continuing into a second region 59 through which the shaft of the tightening screw 39 passes. The first region 55 and the second region 59 are preferably designed in a cylindrical fashion. The following must be stated with regard to the clamping region 57:

It is possible to design an inner cone here; preferably, however, the first region 55 transitions into the second region 59 via a defined arc such that the clamping region 57 is defined by a bent surface that bulges in its cross section in the direction of the longitudinal axis 37, i.e., has a convex design. If an outer cone of a tightening screw 39 is acting on this surface, a linear contact results here in the clamping region 57, such that the clamping forces implied by the arrow K lie in a defined plane 61 and run perpendicular to the central axis of the recess 35, which coincides with the longitudinal axis 37 of a tightening screw that is not shown here.

Finally, it is also conceivable for the first region 55 to transition into the second region 59 via a stage formed by a sink, such that the clamping region 57 is formed by said stage, upon which a flat head of a tightening screw may rest. The surface upon which the flat head rests is disposed in a plane that runs parallel to the plane 54. This case also results in a defined plane in which the clamping forces K act.

Adjustment forces implied by an arrow J are acting on the lower longitudinal side 45′ located opposite the upper longitudinal side 45. From the depiction of FIG. 3, it becomes clear that the adjustment forces act in an engagement region 63 on the cutting tip 13, which lies in the plane 61. Measured from the plane 54, therefore, the clamping forces implied by the arrow K and the adjustment forces implied by the arrow J are acting at the same distance. They lie in the very same plane 61, such that no tilting moment is exerted on the cutting tip 13. Therefore, the cutting tip lies with its back 17 flat on the contact surface 19, which is not shown here but lies in the plane 55, even under the influence of adjustment forces, such that the selected tapering of the cutting tip 13 remains securely maintained and a high surface quality is guaranteed in the machining of a bore surface.

Overall, it becomes clear that the cutting tip 13 is mounted securely and, in particular, precisely in the base 3 of the reamer 1. It is held in the base 3 of the reamer 1 in a twist-proof fashion by the limiting wall 49 and the interior wall 47 of the recess 43 and oriented in a defined angle position by the contact surface 19. Because the contact surface 19 declines from the central axis 9 of the reamer 1 in the direction of the circumferential surface 5, specifically by 1μ/mm to 3μ/mm, preferably by 1 μper 1 mm, the angle of incline of the minor cutting edge 29, i.e., the tapering of the cutting region 23, may be set in a precise fashion and maintained even when adjusting the cutting tip 13.

It has been shown that the design selected here is particularly advantageous for the precise fine machining of bore surfaces by means of the reamer 1.

1-10. (canceled)

11. A reamer comprising:
a base;
at least one cutting tip disposed essentially parallel to a face of the reamer, the at least one cutting tip having a geometrically defined major cutting edge and a geometrically defined minor cutting edge, the at least one cutting tip having a recess therethrough and being held on a contact surface of the base of the reamer by a tightening screw penetrating the cutting tip through the recess, a back of the cutting tip resting against the contact surface; and
an adjustment unit having an adjustment screw acting on the cutting tip that introduces adjustment forces into a lateral surface of the cutting tip;
wherein the recess includes a clamping region, a distance from the clamping region to a rear of the cutting tip measured perpendicular to the rear being equal to a distance from the engagement region of the adjustment forces to the rear of the cutting tip measured perpendicular to the rear of the cutting tip.

12. The reamer according to claim 11, wherein the clamping region in the recess accommodating the tightening screw defines a geometry selected from a group including an arced surface and an inner cone, the geometry cooperating with an outer cone on the tightening screw.

13. The reamer according to claim 12, wherein the outer cone is provided on a head of the tightening screw.

14. The reamer according to claim 11, wherein the cutting tip defines a polygon when viewed from the top.

15. The reamer according to claim 11, wherein the cutting tip defines a parallelogram when viewed from the top.

16. The reamer according to claim 11, wherein the adjustment screw forms an angle with the face of the reamer.

17. The reamer according to claim 11, wherein the adjustment screw forms an acute angle with the face of the reamer.

18. The reamer according to claim 11, further comprising at least one guide strip placed in a circumferential surface of the reamer.

19. The reamer according to claim 18, wherein one cutting tip and three guide strips are provided, a first guide strip lags behind the major and minor cutting edges of the cutting tip by 75°, a second guide strip is located diametrically opposite the major and minor cutting edges, and a third guide strip lags behind the major and minor cutting edges of the cutting tip by 270°.

20. The reamer according to claim 11, wherein the cutting tip includes two cutting regions located diagonally opposite one another, each cutting region having one major and one minor cutting edge.

21. The reamer according to claim 1, wherein the contact surface, viewed from a central axis of the reamer, declines from an inside toward an outside by approximately 1μ/mm such that the minor cutting edge of the at least one cutting tip declines by approximately 1μ/mm to 3μ/mm.

22. The reamer according to claim 11, wherein the contact surface, viewed from a central axis of the reamer, declines from an inside toward an outside by approximately 1μ/mm such that the minor cutting edge of the at least one cutting tip declines by approximately 1μ/mm.
